(19) United States
(12) Patent Application Publication
(10) Pub. No.: US 2026/0299249 A1
(43) Pub. Date: Oct. 1, 2026

(54) PIEZOELECTRIC DRIVING DEVICE AND CAMERA MODULE

(71) Applicant: ALPS ALPINE CO., LTD., Tokyo (JP)

(72) Inventor: Katsutoshi SUZUKI, Fukushima (JP)

(21) Appl. No.: 19/575,021

(22) Filed: Mar. 23, 2026

(30) Foreign Application Priority Data
Mar. 27, 2025 (JP) 2025-054504

(51) Int. Cl. G02B 7/04; H02N 2/10; H04N 23/55; H04N 23/57

(52) U.S. Cl. CPC G02B 7/04; H02N 2/103; H04N 23/55; H04N 23/57

(57) ABSTRACT

A piezoelectric driving device is provided and includes a supporting member; a movable member having a center axis extending in a first direction; and a piezoelectric driver configured to move the movable member along the first direction relative to the supporting member. The piezoelectric driver includes a first piezoelectric driver and a second piezoelectric driver. The movable member includes a first receiving portion and a second receiving portion. The first receiving portion is configured to contact the first piezoelectric driver and receive movement of the first piezoelectric driver. The second receiving portion is configured to contact the second piezoelectric driver and receive movement of the second piezoelectric driver.

### CROSS-REFERENCE TO RELATED APPLICATIONS

This application is based on and claims priority to Japanese Patent Application No. 2025-054504 filed on Mar. 27, 2025, the entire contents of which are hereby incorporated by reference.

### BACKGROUND

### 1. Field of the Invention

The present disclosure relates to a piezoelectric driving device, and to a camera module for installation in a camera-equipped portable phone or the like.

### 2. Description of the Related Art

A lens driving unit configured to move a lens carrier by a piezoelectric driver is known (see Japanese Laid-Open Patent Application Publication No. 2010-097216). This unit is configured to cause a single piezoelectric driver to adhere to an axial guide provided at a lens carrier from only one side of the lens carrier.

### SUMMARY

A piezoelectric driving device according to an embodiment of the present disclosure includes: a supporting member; a movable member having a center axis extending in a first direction; and a piezoelectric driver configured to move the movable member along the first direction relative to the supporting member. The piezoelectric driver includes a first piezoelectric driver and a second piezoelectric driver. The movable member includes a first receiving portion and a second receiving portion. The first receiving portion is configured to contact the first piezoelectric driver and receive movement of the first piezoelectric driver. The second receiving portion is configured to contact the second piezoelectric driver and receive movement of the second piezoelectric driver.

### BRIEF DESCRIPTION OF THE DRAWINGS

FIG. 1 is an exploded perspective diagram of a camera module according to an embodiment of the present disclosure.

FIG. 2 is an exploded perspective diagram of a piezoelectric driving device according to an embodiment of the present disclosure.

FIG. 3 is an exploded perspective diagram of a portion of the piezoelectric driving device illustrated in FIG. 2.

FIG. 4 is an exploded perspective diagram of a biasing member and a piezoelectric driver forming the piezoelectric driving device illustrated in FIG. 2.

FIG. 5 is a diagram illustrating movement of the piezoelectric driver illustrated in FIG. 4.

FIG. 6 is top and bottom plan diagrams of the piezoelectric driving device illustrated in FIG. 2.

FIG. 7 is a cross-sectional diagram of the piezoelectric driving device illustrated in FIG. 2.

FIG. 8 is a diagram illustrating a positional relationship between a guiding portion (rod-like member) and a cover member, a holding member, or a base member forming the piezoelectric driving device illustrated in FIG. 2.

FIG. 9 is a diagram illustrating the positional relationship between the guiding portion (rod-like member) and the cover member, the holding member, or the base member forming the piezoelectric driving device illustrated in FIG. 2.

FIG. 10 is a top plan diagram of the biasing member, a movable member, and the piezoelectric driver forming the piezoelectric driving device illustrated in FIG. 2.

### DETAILED DESCRIPTION OF THE INVENTION

In the above-described configuration, when using a heavy lens or moving other heavy members, there is a possibility that a driving force (thrust) is insufficient.

Therefore, it is desirable to provide a piezoelectric driving device configured to achieve a greater driving force (thrust).

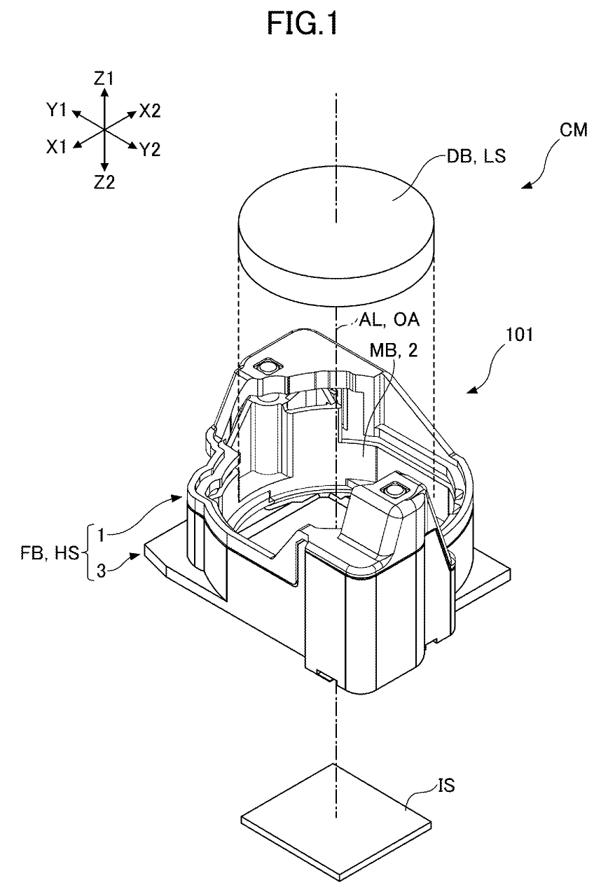

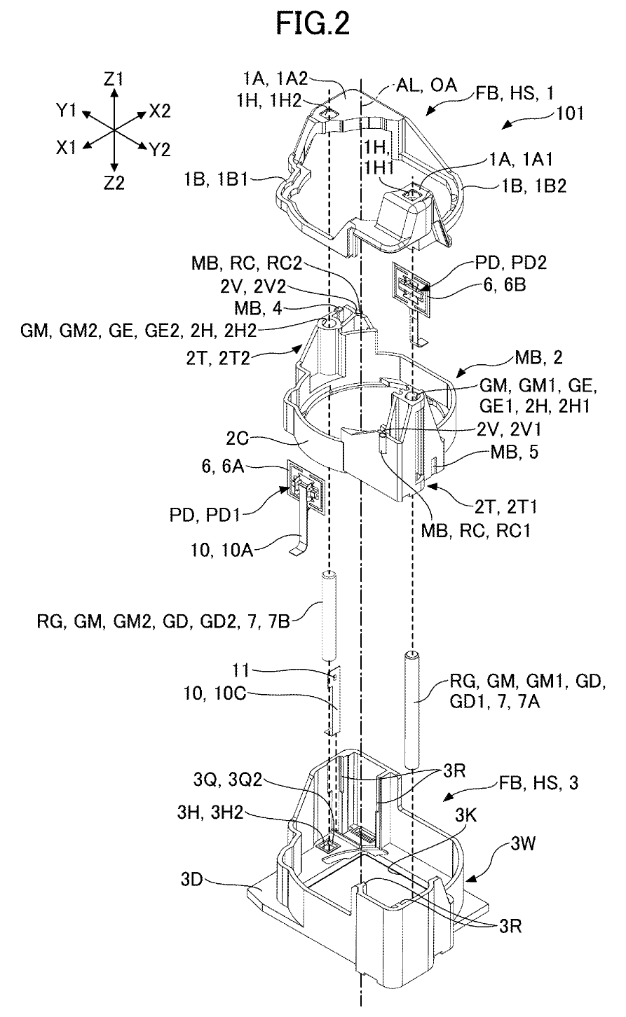

Hereinafter, a piezoelectric driving device 101 according to an embodiment of the present disclosure will be described with reference to FIGS. 1 and 2. FIG. 1 is an exploded perspective diagram of a camera module CM including the piezoelectric driving device 101. FIG. 2 is an exploded perspective diagram of the piezoelectric driving device 101.

In FIG. 1, X1 indicates one direction of an X axis forming a three-dimensional orthogonal coordinate system, and X2 indicates the other direction of the X axis. Y1 indicates one direction of a Y axis forming the three-dimensional orthogonal coordinate system, and Y2 indicates the other direction of the Y axis. Z1 indicates one direction of a Z axis forming the three-dimensional orthogonal coordinate system, and Z2 indicates the other direction of the Z axis. In FIG. 1, an X1 side of the piezoelectric driving device 101 corresponds to a front side (front surface side) of the piezoelectric driving device 101, and an X2 side of the piezoelectric driving device 101 corresponds to a rear side (rear surface side) of the piezoelectric driving device 101. Also, a Y1 side of the piezoelectric driving device 101 corresponds to a left side of the piezoelectric driving device 101, and a Y2 side of the piezoelectric driving device 101 corresponds to a right side of the piezoelectric driving device 101. Similarly, a Z1 side of the piezoelectric driving device 101 corresponds to an upper side (subject side) of the piezoelectric driving device 101, and a Z2 side of the piezoelectric driving device 101 corresponds to a lower side (imaging element side) of the piezoelectric driving device 101. The same applies to the other drawings.

The camera module CM includes: the piezoelectric driving device 101; a lens body LS, which is an example of a driven body DB; and an imaging element IS mounted on a substrate (not shown) to face the lens body LS. The piezoelectric driving device 101 has a substantially rectangular parallelepiped outer shape in a plan view (top plan view) when viewed along a Z-axis direction, and is attached onto the substrate on which the imaging element IS is mounted. The driven body DB may be a mirror, a prism, a diffraction grating, a light-emitting element, a light-receiving element, an imaging element, an optical filter, a shutter, a diaphragm, or any combination thereof. That is, the driven body DB may be any object, as long as it can be driven by the piezoelectric driving device 101. When the driven body DB is an object other than the lens body LS, the imaging element IS may be omitted.

In the illustrated example, the piezoelectric driving device 101 includes a supporting member FB and a movable member MB, as illustrated in FIG. 2. In the illustrated example, the supporting member FB is an example of a fixed member, and includes a cover member 1 and a base member 3. The movable member MB is a member that is movable relative to the supporting member FB, and includes a holding member 2, a first magnetic body 4, a second magnetic body 5, and a receiving member RC. The supporting member FB and the movable member MB are connected by a guide mechanism GM. The movable member MB is supported by the guide mechanism GM to be guided in a predetermined moving direction. In the illustrated example, the guide mechanism GM includes: a guiding portion GD, which is a substantially cylindrical rod-like member 7; and a guided portion GE, which is a through-hole 2H formed in the holding member 2 and receiving the guiding portion GD. Specifically, the guide mechanism GM includes a first guide mechanism GM1 and a second guide mechanism GM2. In the illustrated example, the through-hole 2H is a through-hole extending along the Z-axis direction. Specifically, the first guide mechanism GM1 includes a first guiding portion GD1 (first rod-like member 7A) and a first guided portion GE1 (through-hole 2H1), and the second guide mechanism GM2 includes a second guiding portion GD2 (second rod-like member 7B) and a second guided portion GE2 (through-hole 2H2). The predetermined moving direction includes a first direction (Z-axis direction) parallel to an optical axis direction. The optical axis direction is an example of a direction of a center axis AL of the movable member MB, and includes a direction of an optical axis OA with respect to the lens body LS held by the holding member 2 and a direction parallel to the optical axis OA. The center axis AL is perpendicular to an imaginary plane (XY plane) extending in a second direction (X-axis direction) and a third direction (Y-axis direction). The lens body LS is, for example, a cylindrical lens barrel including at least one lens. The movable member MB is configured to be moved in the predetermined moving direction (Z-axis direction, i.e., the first direction) due to a force generated by a piezoelectric driver PD, which is an example of a driver.

The cover member 1 is a member forming a portion of a housing HS. In the illustrated example, the cover member 1 is formed of a synthetic resin. However, the cover member 1 may be formed of a metal. In the illustrated example, the cover member 1 is configured to cover the top of the movable member MB, as illustrated in FIG. 2. Specifically, the cover member 1 includes: two top plates 1A (first top plate 1A1 and second top plate 1A2) each including a through-hole 1H into which the guiding portion GD is inserted; and two connecting portions 1B (first connecting portion 1B1 and second connecting portion 1B2) each configured to connect the two top plates 1A. The first top plate 1A1 and the second top plate 1A2 face each other across the optical axis OA. In the illustrated example, the through-hole 1H is a substantially circular through-hole extending along the Z-axis direction.

The base member 3 is a member forming a portion of the housing HS. In the illustrated example, the base member 3 is formed of a synthetic resin. However, the base member 3 may be formed of a metal. In the illustrated example, the base member 3 is configured to cover a side portion and a bottom portion of the movable member MB, as illustrated in FIG. 2. Specifically, the base member 3 includes: a bottom plate 3D including a through-hole 3H into which the guiding portion GD is inserted; and a cylindrical side plate 3W extending upward from the bottom plate 3D. In the illustrated example, the through-hole 3H is a substantially circular through-hole extending along the Z-axis direction. An opening 3K having a substantially rectangular shape in a plan view when viewed along the optical axis direction is formed in a center portion of the bottom plate 3D. Also, the base member 3 is bonded to the cover member 1 with an adhesive or the like to form the housing HS along with the cover member 1.

The holding member 2 is configured to hold the driven body DB. In the illustrated example, the holding member 2 is formed through injection molding of a synthetic resin, such as a liquid crystal polymer (LCP) or the like. The holding member 2 is configured to hold the lens body LS by fixing the lens body LS to the interior of a substantially cylindrical tubular portion 2C with an adhesive. The holding member 2 includes a projection 2T projecting in a radial direction from the outer circumferential surface of the tubular portion 2C. In the illustrated example, the projection 2T includes: a first projection 2T1 including the through-hole 2H1, which functions as the first guided portion GE1; and a second projection 2T2 including the through-hole 2H2, which functions as the second guided portion GE2. When the driven body DB held by the tubular portion 2C of the holding member 2 is the lens body LS, the center axis AL of the movable member MB coincides with the optical axis OA of the lens body LS. Therefore, the center axis AL of the movable member MB substantially coincides with a straight line extending in the Z-axis direction through the center of the inner shape of the tubular portion 2C of the holding member 2 in a plan view when viewed along the Z-axis direction. However, the center axis AL of the movable member MB may be at a position deviating from the center of the inner shape of the tubular portion 2C.

A first magnetic body 4 is a member forming a position detecting system along with a magnetic sensor 11. The position detecting system is a system configured to detect the position of the holding member 2 in the first direction (Z-axis direction). In the illustrated example, the first magnetic body 4 is a permanent magnet that is dipole magnetized along the Z-axis direction, and is attached to the second projection 2T2 of the holding member 2.

The second magnetic body 5 is a member that functions as a counterweight of the first magnetic body 4. In the illustrated example, the second magnetic body 5 is a permanent magnet that is dipole magnetized along the Z-axis direction, and is attached to the first projection 2T1 of the holding member 2. Specifically, the first magnetic body 4 and the second magnetic body 5 are disposed such that the center of mass (center of gravity) of the movable member MB (holding member 2, first magnetic body 4, second magnetic body 5, and receiving member RC) is located on the optical axis OA.

The magnetic sensor 11 is a member forming the position detecting system along with the first magnetic body 4. In the illustrated example, the magnetic sensor 11 is attached to a flexible wiring board 10 (third flexible wiring board 10C) fixed to the supporting member FB (side plate 3W of the base member 3). The magnetic sensor 11 is disposed to face the first magnetic body 4 to detect magnetism generated by the first magnetic body 4 attached to the movable member MB. Specifically, the magnetic sensor 11 is a Hall sensor, and is configured to measure a voltage value varying with the magnitude of a magnetic field generated by the first magnetic body 4 and received by the magnetic sensor 11, and to output the measured voltage value to a control device (not shown). In the illustrated example, the piezoelectric driving device 101 does not include any other magnetic sensor facing the second magnetic body 5 serving as the counterweight. However, the piezoelectric driving device 101 may include another magnetic sensor disposed to face the second magnetic body 5. In this case, another position detecting system including the second magnetic body 5 and the other magnetic sensor can work in cooperation with the position detecting system including the first magnetic body 4 and the magnetic sensor 11, thereby detecting a posture of the holding member 2 (positions in the X-, Y-, and Z-axis directions, and rotations about the X, Y, and Z axes).

The receiving member RC is a member configured to receive a driving force generated by the piezoelectric driver PD. Specifically, the receiving member RC is a cylindrical member that is formed of a metal, such as a copper-titanium alloy, stainless steel, or the like, and extends along the Z-axis direction. The receiving member RC may be formed of another metal or a ceramic. The other metal may be a magnetic or non-magnetic metal. In the illustrated example, the receiving member RC includes a first receiving member RC1 and a second receiving member RC2. The first receiving member RC1 is fitted into a V-shaped groove 2V (first V-shaped groove 2V1), formed at the front end of the first projection 2T1 of the holding member 2, and fixed with an adhesive. The first receiving member RC1 is provided to be movable in the Z-axis direction along with the holding member 2. Similarly, the second receiving member RC2 is fitted into a second V-shaped groove 2V2, formed at the rear end of the second projection 2T2 of the holding member 2, and fixed with an adhesive. The second receiving member RC2 is provided to be movable in the Z-axis direction along with the holding member 2. The V-shaped groove 2V may be a U-shaped groove.

The biasing member 6 is configured to bias the piezoelectric driver PD toward the receiving member RC. In the illustrated example, the biasing member 6 is formed by a leaf spring formed by pressing a metal plate of a copper-titanium alloy. The metal plate may be formed of another metal, such as stainless steel or the like. Specifically, the biasing member 6 includes: a first biasing member 6A formed by a first leaf spring; and a second biasing member 6B formed by a second leaf spring. In the illustrated example, the biasing member 6 has a substantially rectangular outer shape, an outer portion of the biasing member 6 is fixed to a recess 3R of the side plate 3W of the base member 3 with an adhesive, and an inner portion of the biasing member 6 is fixed to the piezoelectric driver PD. Specifically, the first biasing member 6A is configured to press a first piezoelectric driver PD1 toward the first receiving member RC1 fixed to the holding member 2, and the second biasing member 6B is configured to press a second piezoelectric driver PD2 toward the second receiving member RC2 fixed to the holding member 2.

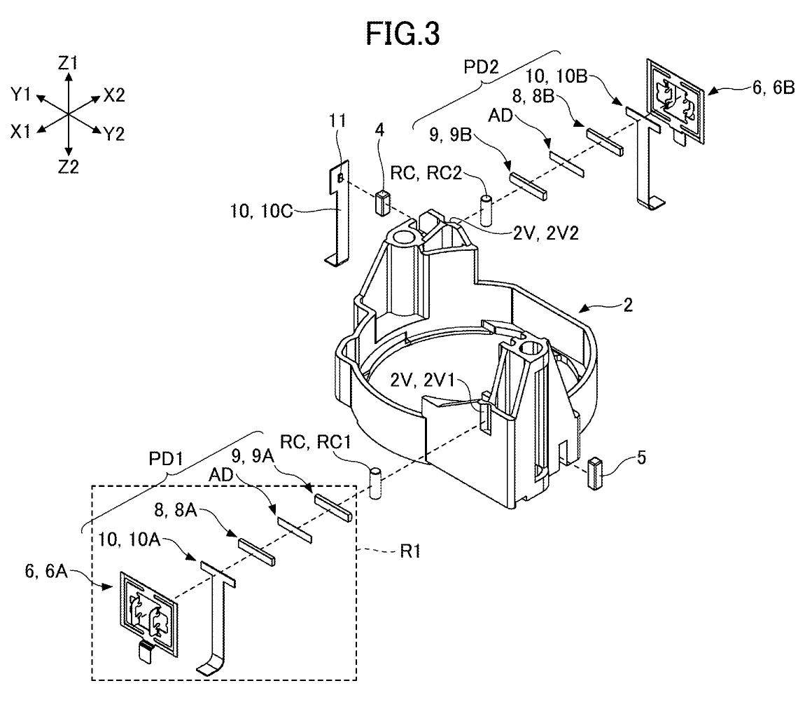

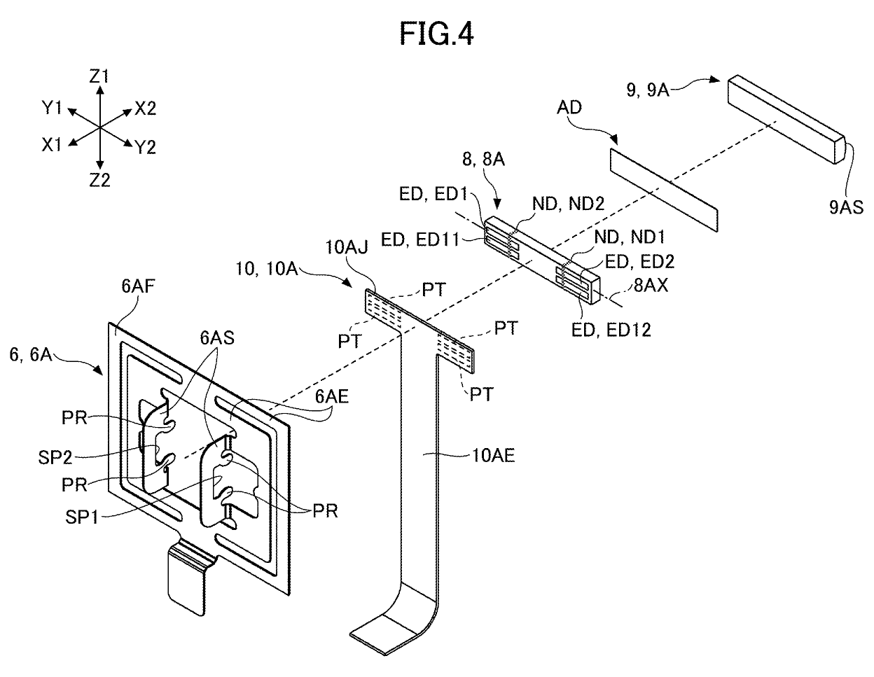

Next, details of the piezoelectric driver PD will be described with reference to FIGS. 3 and 4. FIG. 3 is an exploded perspective diagram of a portion of the piezoelectric driving device 101 including the piezoelectric driver PD held by the biasing member 6. FIG. 4 is an enlarged diagram of a region R1 enclosed by a broken line in FIG. 3.

The piezoelectric driver PD is configured to move the movable member MB along the predetermined moving direction (Z-axis direction). In the illustrated example, the piezoelectric driver PD is an example of a frictional driver using the driving system disclosed in U.S. Patent No. 7,786,648, and includes a piezoelectric element 8, a contact member 9, and a flexible wiring board 10. The piezoelectric driver PD is configured to be biased by the biasing member 6 and pressed against the receiving member RC.

Specifically, the piezoelectric driver PD includes: the first piezoelectric driver PD1 configured to move the holding member 2 in the first direction (Z-axis direction); and the second piezoelectric driver PD2 configured to move the holding member 2 in the first direction (Z-axis direction).

The first piezoelectric driver PD1 includes a first piezoelectric element 8A, a first contact member 9A, and a first flexible wiring board 10A, and is configured to be biased by the first biasing member 6A and pressed against the first receiving member RC1 fixed to the holding member 2.

The second piezoelectric driver PD2 includes a second piezoelectric element 8B, a second contact member 9B, and a second flexible wiring board 10B, and is configured to be biassed by the second biasing member 6B and pressed against the second receiving member RC2 fixed to the holding member 2.

Specifically, each of the first piezoelectric element 8A and the second piezoelectric element 8B is configured to achieve a bending vibration in response to application of a voltage. In the illustrated example, the first piezoelectric element 8A extends in the third direction (Y-axis direction) along a first rotation axis 8AX, as illustrated in FIG. 4. The same applies to the second piezoelectric element 8B. Also, each of the first piezoelectric element 8A and the second piezoelectric element 8B is configured to achieve a bending vibration having two nodes (nodes ND). When the bending vibration is performed, portions corresponding to the two nodes ND generate substantially no vibration. In FIG. 4, for ease of understanding of the description, the positions of the nodes ND in the first piezoelectric element 8A are indicated by cross patterns. The positions of the nodes ND in the piezoelectric element 8 include the position of a first node ND1 and the position of a second node ND2. The positions of the nodes ND correspond to positions away from the ends of the piezoelectric element 8 by a predetermined distance. The predetermined distance is, for example, substantially 1/4 of the total length of the piezoelectric element 8.

The first flexible wiring board 10A is a flexible wiring board including a conductive pattern, and is configured to electrically connect an external voltage supply source (control circuit) and the first piezoelectric element 8A. In the illustrated example, the first flexible wiring board 10A is configured to apply a voltage to the first piezoelectric element 8A. Specifically, as illustrated in FIG. 4, the first flexible wiring board 10A includes a bonded portion 10AJ to be bonded to the first piezoelectric element 8A, and an extension 10AE extending in a Z2 direction from the bonded portion 10AJ. The first piezoelectric element 8A extends along the first rotation axis 8AX, and is bonded to the rear (X2-side) surface of the first flexible wiring board 10A with an adhesive. In the illustrated example, the first piezoelectric element 8A includes electrodes ED at four corners of the front (X1-side) surface. The four electrodes ED in the first piezoelectric element 8A are bonded to four connecting portions PT formed on the rear surface of the first flexible wiring board 10A with a conductive adhesive. The same applies to the second flexible wiring board 10B.

In the illustrated example, the adhesive is an anisotropic conductive film, which is heated and pressurized in a state of being disposed between the piezoelectric element 8 and the flexible wiring board 10, thereby bonding the piezoelectric element 8 and the flexible wiring board 10 to each other. As a result, the four electrodes ED of the piezoelectric element 8 and the four connecting portions PT, which are portions of the conductive pattern of the flexible wiring board 10, are individually electrically connected. The adhesive may be a conductive adhesive, solder, or the like.

Also, in the illustrated example, a conductive pattern is respectively formed on both surfaces of the flexible wiring board 10, and an insulating film covering the conductive pattern is respectively formed on both surfaces of the flexible wiring board 10. For achieving reliable insulation, an insulating protective film is formed at a portion of the flexible wiring board 10 to contact the piezoelectric element 8 and at a portion of the flexible wiring board 10 to contact the biasing member 6. No insulating film (insulating protective film) is provided at the four connecting portions PT.

The first piezoelectric driver PD1 is biased rearward by the first biasing member 6A fixed to the base member 3, and is pressed against the first receiving member RC1. In the illustrated example, the first biasing member 6A is configured to contact (to be bonded to) the front (X1-side) surface of the first flexible wiring board 10A at positions (first position SP1 and second position SP2) corresponding to the two nodes ND formed during the bending vibration of the first piezoelectric element 8A. The bonding between the first biasing member 6A and the first flexible wiring board 10A is, for example, achieved with an adhesive.

The second piezoelectric driver PD2 is biased forward by the second biasing member 6B fixed to the base member 3, and is pressed against the second receiving member RC2. In the illustrated example, the second biasing member 6B is configured to contact the rear (X2-side) surface of the second flexible wiring board 10B at positions corresponding to the two nodes ND formed during the bending vibration of the second piezoelectric element 8B. The bonding between the second biasing member 6B and the second flexible wiring board 10B is, for example, achieved with an adhesive.

The biasing member 6 is formed by a leaf spring of a single metal plate. In the illustrated example, the first biasing member 6A includes: an outer portion 6AF whose ends in the Y-axis direction are both fixed to the recess 3R (see FIG. 2) of the base member 3; a support 6AS configured to support the first piezoelectric driver PD1; and an elastically deformable portion 6AE between the support 6AS and both of the ends of the outer portion 6AF, as illustrated in FIG. 4. The same applies to the second biasing member 6B.

The first piezoelectric driver PD1 is attached to the first biasing member 6A such that the front surface (X1-side surface) of the bonded portion 10AJ of the first flexible wiring board 10A is fixed to the support 6AS with an adhesive. Specifically, the first piezoelectric driver PD1 is attached to the first biasing member 6A such that portions corresponding to the first node ND1 and the second node ND2 of the first piezoelectric element 8A in the bonded portion 10AJ are fixed, with an adhesive, to the first position SP1 and the second position SP2 in the support 6AS. That is, the first piezoelectric driver PD1 is attached to the first biasing member 6A such that portions of the front surface (X1-side surface) of the bonded portion 10AJ not corresponding to the first node ND1 and the second node ND2 of the first piezoelectric element 8A do not contact the support 6AS of the first biasing member 6A. The same applies to the second piezoelectric driver PD2.

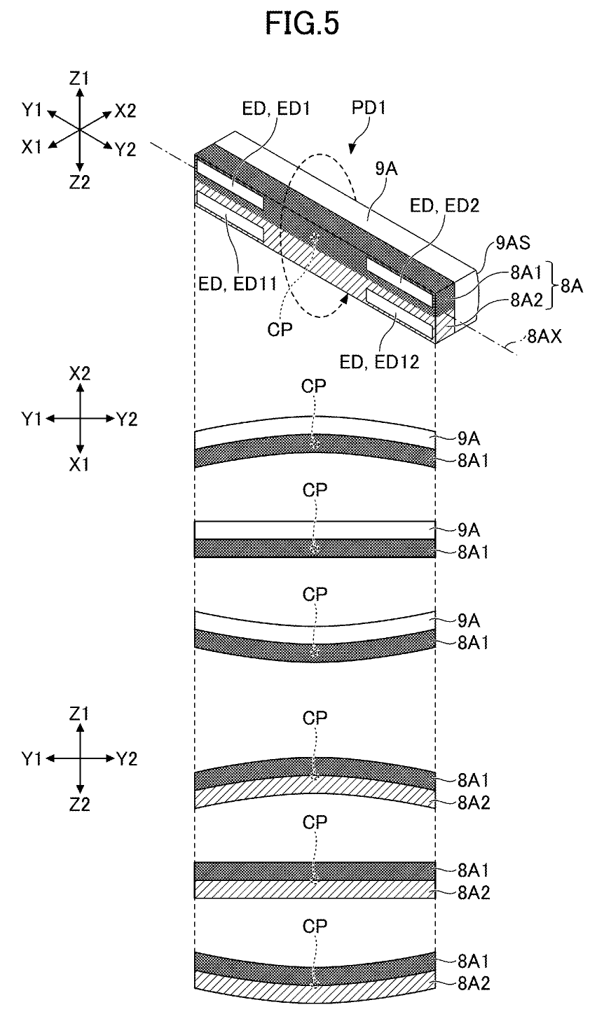

Next, the movement of the first piezoelectric driver PD1 will be described with reference to FIG. 5. FIG. 5 is a diagram illustrating the first piezoelectric element 8A and the first contact member 9A that form the first piezoelectric driver PD1. For ease of understanding, FIG. 5 does not illustrate the first flexible wiring board 10A. Specifically, the uppermost diagram in FIG. 5 is a perspective diagram of the first piezoelectric element 8A and the first contact member 9A. The second, third, and fourth diagrams from the top in FIG. 5 are top plan diagrams of the first piezoelectric element 8A and the first contact member 9A. The fifth, sixth, and seventh diagrams from the top in FIG. 5 are front plan diagrams of the first piezoelectric element 8A and the first contact member 9A. For ease of understanding, FIG. 5 exaggerates deflecting shapes of the first piezoelectric driver PD1. The following description made with reference to FIG. 5 relates to the movement of the first piezoelectric driver PD1, and is similarly applied to the movement of the second piezoelectric driver PD2. This is because the first piezoelectric driver PD1 and the second piezoelectric driver PD2 have the same configuration.

In the illustrated example, the first piezoelectric element 8A includes two portions (first portion 8A1 and second portion 8A2) disposed side by side in the first direction (Z-axis direction), and is provided with two electrodes ED configured to individually apply a voltage to each of these two portions. Specifically, a first electrode ED1 and a second electrode ED2 are formed in the first portion 8A1, and a first electrode ED11 and a second electrode ED12 are formed in the second portion 8A2. In FIG. 5, for ease of understanding, the first portion 8A1 is indicated by a dot pattern, and the second portion 8A2 is indicated by a diagonal line pattern.

When application of a voltage to the first portion 8A1 and application of a voltage to the second portion 8A2 are individually performed at appropriate timings, for example, the first piezoelectric driver PD1 can cause the first piezoelectric element 8A to perform a bending vibration (circular motion) such that a trajectory drawn by a center point CP, which is a predetermined point of the first piezoelectric element 8A (first piezoelectric driver PD1), is a circular trajectory around the first rotation axis 8AX. That is, the first piezoelectric element 8A can achieve movement in which the center point CP draws a circle (circular motion). In the illustrated example, the center point CP of the first piezoelectric element 8A is the center of gravity of the first piezoelectric element 8A, and the first rotation axis 8AX is parallel to the Y axis. However, the center point CP of the circular motion may be located in the first contact member 9A fixed to the first piezoelectric element 8A. This is because the first contact member 9A moves in a circular motion along with the first piezoelectric element 8A. Also, when application of a voltage to the first portion 8A1 and the second portion 8A2 is performed at an appropriate timing, the first piezoelectric driver PD1 can switch a moving direction (rotation direction) of the center point CP following the circular trajectory between clockwise and counterclockwise when viewed from the Y1 side. By the switching of the rotation direction, the first piezoelectric driver PD1 can switch the moving direction, along the first direction (Z-axis direction), of the first receiving member RC1 (and the holding member 2 (movable member MB) to which the first receiving member RC1 is fixed). The circle (circular trajectory) drawn by the center point CP may be a substantially circular shape including a perfect circle.

A broken-line arrow drawn around the first piezoelectric element 8A in the uppermost diagram of FIG. 5 indicates an example of the bending vibration of the first piezoelectric element 8A (circular motion in which the first piezoelectric element 8A rotates clockwise when viewed from the Y1 side around the first rotation axis 8AX while deflecting). In this case, the movable member MB including the first receiving member RC1 in contact with the first contact member 9A of the first piezoelectric driver PD1 moves upward (Z1 direction). Although not indicated by an arrow, the first piezoelectric element 8A can rotate counterclockwise around the first rotation axis 8AX when viewed from the Y1 side while deflecting. In this case, the movable member MB including the first receiving member RC1 in contact with the first contact member 9A of the first piezoelectric driver PD1 moves downward (Z2 direction).

That is, the holding member 2 to which the first receiving member RC1 is attached is moved upward (Z1 direction) when the rotation direction of the center point CP of the first piezoelectric element 8A is clockwise in a left side view, and is moved downward (Z2 direction) when the rotation direction of the center point CP of the first piezoelectric element 8A is counterclockwise in the left side view.

The first contact member 9A is attached to the first piezoelectric element 8A, and is configured to contact the first receiving member RC1. In the illustrated example, the first contact member 9A is bonded to the rear (X2-side) surface of the first piezoelectric element 8A with an adhesive AD (see FIG. 4) to entirely cover the rear surface of the first piezoelectric element 8A. The first contact member 9A is formed of a metal, such as a copper-titanium alloy, stainless steel, or the like, and is configured to have a thickness appropriate for performing a bending vibration (circular motion) along with the bending vibration (circular motion) of the first piezoelectric element 8A. In the illustrated example, the first contact member 9A is a friction plate formed of stainless steel. The first contact member 9A extends to have a length that is the same as that of the first piezoelectric element 8A in a direction (Y-axis direction) that is the same as the extending direction of the first piezoelectric element 8A. The first contact member 9A is configured to contact the first receiving member RC1 at the center in the extending direction. Specifically, the first contact member 9A is configured to contact the first receiving member RC1 at a portion in which the amplitude of the bending vibration (circular motion) is maximum (a portion corresponding to the antinode of the bending vibration). In the illustrated example, the first contact member 9A has a curved surface in which the contact surface 9AS on a side (X2 side) of the first contact member 9A to contact the first receiving member RC1 projects toward the X2 side. That is, the contact surface 9AS is configured to form a surface having a single projection. Also, the first piezoelectric driver PD1 is configured to contact (to be bonded to) a projection PR (see FIG. 4), provided at the support 6AS of the first biasing member 6A, respectively at the top and bottom surfaces of the first contact member 9A, rather than the first piezoelectric element 8A. This is for the first biasing member 6A to support substantially non-vibrating portions of the top and bottom surfaces of the first piezoelectric driver PD1. In other words, this is for preventing the first biasing member 6A from interfering with the bending vibration (circular motion) of the first piezoelectric driver PD1. The same applies to the second piezoelectric driver PD2.

The first receiving member RC1 formed of a metal is caused to contact the first contact member 9A formed of a metal in order to prevent wear of the movable member MB (holding member 2) due to contact between the movable member MB (holding member 2) formed of a synthetic resin and the first contact member 9A formed of a metal. As long as the contact between the first receiving member RC1 and the first contact member 9A can be achieved, the length of the first contact member 9A in the Y-axis direction may be different from the length of the first piezoelectric element 8A in the Y-axis direction. For example, the length of the first contact member 9A in the Y-axis direction may be smaller than the length of the first piezoelectric element 8A in the Y-axis direction. However, the length of the first contact member 9A in the extending direction (Y-axis direction) is preferably equal to or greater than the length of the first piezoelectric element 8A.

When the first electrode ED1 is connected to a high potential and the second electrode ED2 is connected to a low potential such that the first portion 8A1 contracts, and when the first electrode ED11 is connected to a high potential and the second electrode ED12 is connected to a low potential such that the second portion 8A2 contracts, each of the first piezoelectric element 8A and the first contact member 9A deflects to project rearward (X2 side), as illustrated in the second diagram from the top. In the following, the state of the first piezoelectric driver PD1 in which each of the first piezoelectric element 8A and the first contact member 9A projects rearward is also referred to as a “rear side projecting state”.

When the first electrode ED1 and the second electrode ED2 are connected to the same potential, or application of a voltage to each of the first electrode ED1 and the second electrode ED2 is stopped such that the first portion 8A1 does not extend or contract, and when the first electrode ED11 and the second electrode ED12 are connected to the same potential, or application of a voltage to each of the first electrode ED11 and the second electrode ED12 is stopped such that the second portion 8A2 does not extend and contract, each of the first piezoelectric element 8A and the first contact member 9A extends in a straight line, as illustrated in the third diagram from the top and the sixth diagram from the top. In the following, the state of the first piezoelectric driver PD1 in which each of the first piezoelectric element 8A and the first contact member 9A extends in a straight line is also referred to as a “neutral state”. Further, the state in which the application of a voltage is stopped is also referred to as an “initial state”.

Also, when the first electrode ED1 is connected to a low potential and the second electrode ED2 is connected to a high potential such that the first portion 8A1 extends, and the first electrode ED11 is connected to a low potential and the second electrode ED12 is connected to a high potential such that the second portion 8A2 extends, each of the first piezoelectric element 8A and the first contact member 9A deflects to project toward the front side (X1 side), as illustrated in the fourth diagram from the top. In the following, the state of the first piezoelectric driver PD1 in which each of the first piezoelectric element 8A and the first contact member 9A projects toward the front side is also referred to as a “front side projecting state”.

When the first electrode ED1 is connected to a low potential and the second electrode ED2 is connected to a high potential such that the first portion 8A1 extends, and when the first electrode ED11 is connected to a high potential and the second electrode ED12 is connected to a low potential such that the second portion 8A2 contracts, each of the first piezoelectric element 8A and the first contact member 9A deflects to project upward (Z1 side), as illustrated in the fifth diagram from the top. In the following, the state of the first piezoelectric driver PD1 in which each of the first piezoelectric element 8A and the first contact member 9A projects upward is also referred to as an “upper side projecting state”.

When the first electrode ED1 is connected to a high potential and the second electrode ED2 is connected to a low potential such that the first portion 8A1 contracts, and when the first electrode ED11 is connected to a low potential and the second electrode ED12 is connected to a high potential such that the second portion 8A2 extends, each of the first piezoelectric element 8A and the first contact member 9A deflects to project downward (Z2 side), as illustrated in the seventh diagram from the top. In the following, the state of the first piezoelectric driver PD1 in which each of the first piezoelectric element 8A and the first contact member 9A projects downward is also referred to as a “lower side projecting state”.

When a voltage is applied between the first electrode ED1 (first electrode ED11) and the second electrode ED2 (second electrode ED12) for extending or contracting the first portion 8A1 (second portion 8A2) in the extending direction, the first contact member 9A fixed to one surface of the first piezoelectric element 8A does not change its dimension in the extending direction. Therefore, the first piezoelectric driver PD1 deforms into the state described above. The first flexible wiring board 10A fixed to the other surface of the first piezoelectric element 8A can deform following the change in shape of the first piezoelectric element 8A.

The first piezoelectric driver PD1 can perform a circular motion rotating clockwise when viewed from the Y1 side, by repeatedly changing its state in the order of the upper side projecting state, the front side projecting state, the lower side projecting state, the rear side projecting state, the upper side projecting state, etc. Also, the first piezoelectric driver PD1 can perform a circular motion rotating counterclockwise when viewed from the Y1 side, by repeatedly changing its state in the order of the upper side projecting state, the rear side projecting state, the lower side projecting state, the front side projecting state, the upper side projecting state, etc. The first piezoelectric driver PD1 can perform an up-down movement by repeatedly changing its state in the order of the upper side projecting state, the lower side projecting state, the upper side projecting state, etc., and can perform a front-rear movement by repeatedly changing its state in the order of the front side projecting state, the rear side projecting state, the front side projecting state, etc.

In the illustrated example, the first piezoelectric driver PD1 is configured such that, when the first electrode ED1 is connected to a high potential and the second electrode ED2 is connected to a low potential, the first portion 8A1 contracts, and when the first electrode ED1 is connected to a low potential and the second electrode ED2 is connected to a high potential, the first portion 8A1 extends. Alternatively, the first piezoelectric driver PD1 may be configured such that, when the first electrode ED1 is connected to a low potential and the second electrode ED2 is connected to a high potential, the first portion 8A1 contracts, and when the first electrode ED1 is connected to a high potential and the second electrode ED2 is connected to a low potential, the first portion 8A1 extends. The same applies to the second portion 8A2.

Although, in the illustrated example, the piezoelectric driving device 101 drives the first piezoelectric driver PD1 and the second piezoelectric driver PD2 in synchronization with each other, the piezoelectric driving device 101 may drive the first piezoelectric driver PD1 and the second piezoelectric driver PD2 at different timings, if necessary.

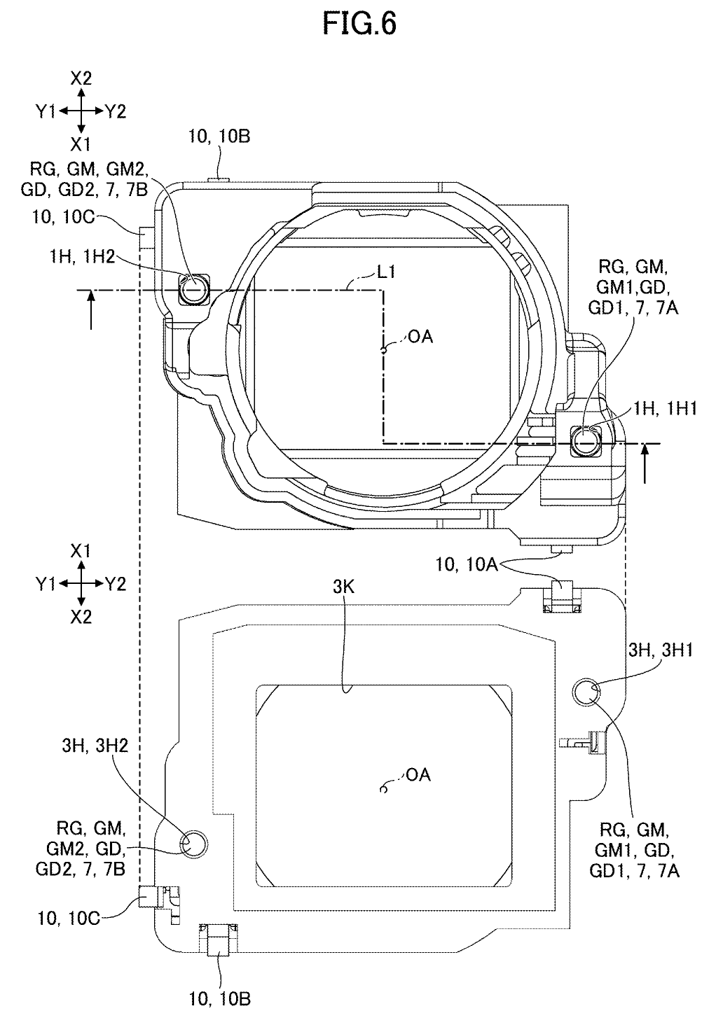

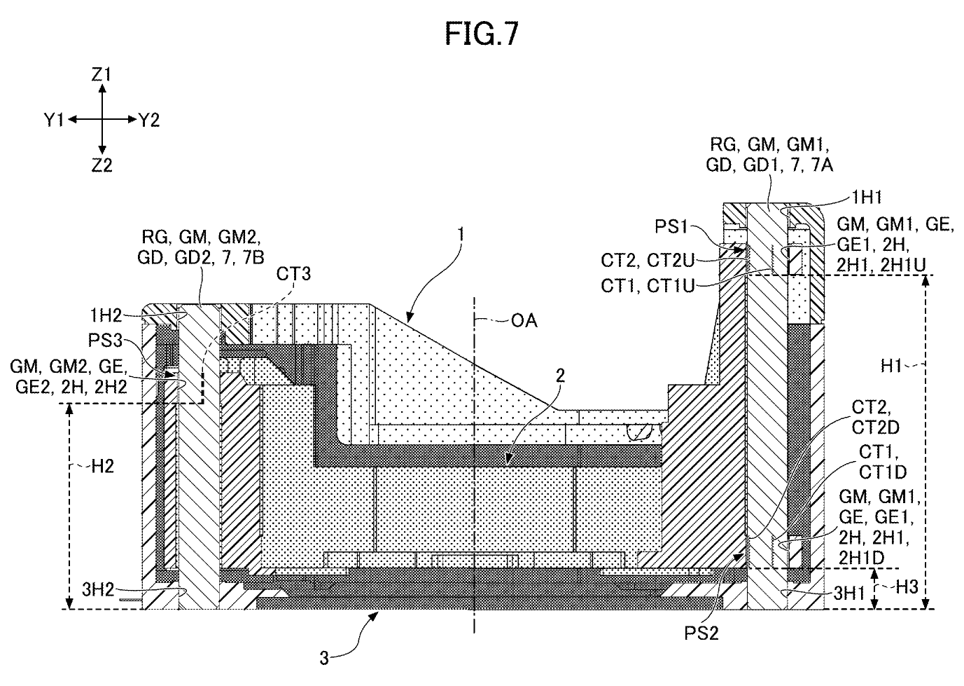

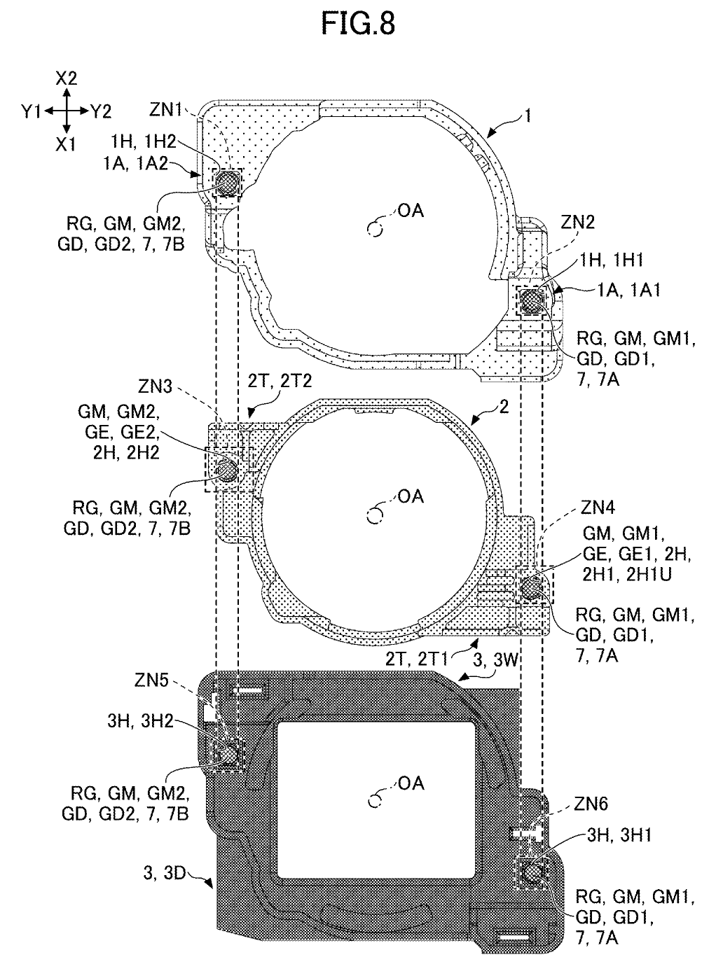

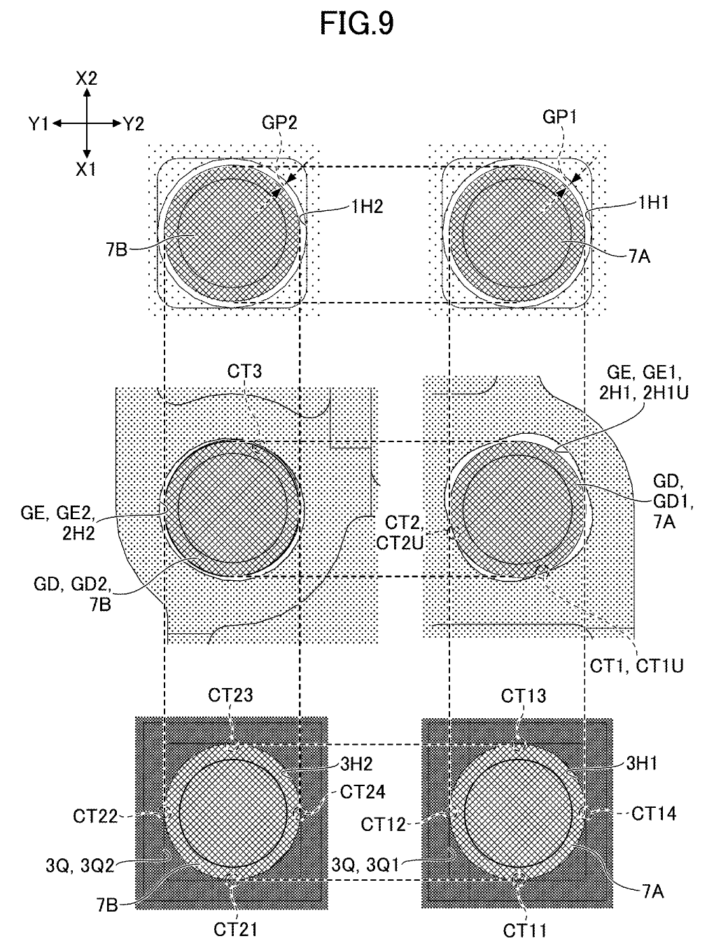

Next, the guide mechanism GM will be described in detail with reference to FIGS. 6 to 9. FIG. 6 is a diagram illustrating a configuration example of the piezoelectric driving device 101. Specifically, the upper diagram of FIG. 6 is a top plan diagram of the piezoelectric driving device 101, and the lower diagram of FIG. 6 is a bottom plan diagram of the piezoelectric driving device 101. FIG. 7 is a cross-sectional diagram of the piezoelectric driving device 101. Specifically, FIG. 7 is a diagram of a cross section, when viewed from the X1 side, of the piezoelectric driving device 101 in an imaginary plane parallel to the optical axis OA including a cutting line L1 indicated by a dash-dot line in the upper diagram of FIG. 6. FIGS. 8 and 9 are diagrams illustrating a positional relationship between the guiding portion GD (rod-like member 7) and the cover member 1, the holding member 2, or the base member 3 forming the piezoelectric driving device 101. Specifically, the upper diagram of FIG. 8 is a top plan diagram of the cover member 1 and the rod-like member 7, the center diagram of FIG. 8 is a top plan diagram of the holding member 2 and the rod-like member 7, and the lower diagram of FIG. 8 is a top plan diagram of the base member 3 and the rod-like member 7. The upper-left diagram of FIG. 9 is an enlarged diagram of a region ZN1 enclosed by a broken line in the upper diagram of FIG. 8, and the upper-right diagram of FIG. 9 is an enlarged diagram of a region ZN2 enclosed by a broken line in the upper diagram of FIG. 8. The center-left diagram of FIG. 9 is an enlarged diagram of a region ZN3 enclosed by a broken line in the center diagram of FIG. 8, and the center-right diagram of FIG. 9 is an enlarged diagram of a region ZN4 enclosed by a broken line in the center diagram of FIG. 8. The lower-left diagram of FIG. 9 is an enlarged diagram of a region ZN5 enclosed by a broken line in the lower diagram of FIG. 8, and the lower-right diagram of FIG. 9 is an enlarged diagram of a region ZN6 enclosed by a broken line in the lower diagram of FIG. 8.

The guide mechanism GM is configured to guide the movable member MB, which is to move relative to the supporting member FB, along a predetermined moving direction. In the illustrated example, the guide mechanism GM includes the first guide mechanism GM1 and the second guide mechanism GM2. Each of the first guide mechanism GM1 and the second guide mechanism GM2 is configured to guide the movement of the holding member 2 in the first direction (Z-axis direction).

In the illustrated example, the guide mechanism GM includes the guiding portion GD and the guided portion GE. Specifically, the first guide mechanism GM1 includes the first guiding portion GD1 and the first guided portion GE1, and the second guide mechanism GM2 includes the second guiding portion GD2 and the second guided portion GE2.

In the illustrated example, the guiding portion GD is formed by the rod-like member 7 extending along the Z-axis direction, and the guided portion GE is formed by the through-hole 2H formed in the projection 2T of the holding member 2. Specifically, the first guiding portion GD1 is formed by the first rod-like member 7A, and the second guiding portion GD2 is formed by the second rod-like member 7B. The first guided portion GE1 is formed by the through-hole 2H1 formed in the first projection 2T1 of the holding member 2, and the second guided portion GE2 is formed by the through-hole 2H2 formed in the second projection 2T2 of the holding member 2.

The rod-like member 7 is a substantially cylindrical member formed of a metal or ceramic. In the illustrated example, the rod-like member 7 is formed of a metal, and includes the first rod-like member 7A and the second rod-like member 7B. As illustrated in FIG. 7, the dimension of the first rod-like member 7A in the Z-axis direction is larger than the dimension of the second rod-like member 7B in the Z-axis direction.

Specifically, as illustrated in FIG. 8, the first rod-like member 7A is inserted into the through-hole 1H1 formed in the first top plate 1A1 of the cover member 1, the through-hole 2H1 formed in the first projection 2T1 of the holding member 2, and a through-hole 3H1 formed in the bottom plate 3D of the base member 3. Also, the second rod-like member 7B is inserted into the through-hole 1H2 formed in the second top plate 1A2 of the cover member 1, the through-hole 2H2 formed in the second projection 2T2 of the holding member 2, and a through-hole 3H2 formed in the bottom plate 3D of the base member 3.

More specifically, as illustrated in the upper-right diagram of FIG. 9, the first rod-like member 7A is disposed across a gap GP1 from the inner circumferential surface of the through-hole 1H1 not to contact the inner circumferential surface of the through-hole 1H1, which is substantially circular in a plan view. Similarly, as illustrated in the upper-left diagram of FIG. 9, the second rod-like member 7B is disposed across a gap GP2 from the inner circumferential surface of the through-hole 1H2 not to contact the inner circumferential surface of the through-hole 1H2, which is substantially circular in a plan view.

Also, as illustrated in the center-right diagram of FIG. 9, the first rod-like member 7A is disposed to contact the inner circumferential surface of the through-hole 2H1, which is substantially rectangular in a plan view, at two contact portions (contact portions CT1 and CT2). Instead of a penetrating hole, the through-hole 2H1 may be a notch (e.g., a V-shaped groove or a U-shaped groove) that provides two surfaces (flat surfaces) serving as the two contact portions (contact portions CT1 and CT2). As illustrated in the center-left diagram of FIG. 9, the second rod-like member 7B is disposed to contact the inner circumferential surface of the through-hole 2H2, which is substantially circular in a plan view, at one contact portion (contact portion CT3). Instead of a penetrating hole, the through-hole 2H2 may be a notch that provides one surface (flat surface) serving as the one contact portion (contact portion CT3). That is, the holding member 2 is configured to be supported at three points (contact portions CT1, CT2, and CT3) by the guiding portion GD (first rod-like member 7A and second rod-like member 7B) in a plan view. This configuration has the effect of stably supporting the holding member 2 using the guiding portion GD (first rod-like member 7A and second rod-like member 7B). In FIG. 7, for ease of understanding, the contact portions CT1 and CT2 are indicated by cross patterns, and the contact portion CT3, which is hidden behind the second rod-like member 7B to be invisible, is indicated by a broken line.

As illustrated in FIG. 7, the through-hole 2H1 includes an upper through-hole 2H1Udisposed to contact the upper portion of the first rod-like member 7A, and a lower through-hole 2H1Ddisposed to contact the lower portion of the first rod-like member 7A. As illustrated in the right-center diagram of FIG. 9, the first rod-like member 7A is disposed to contact the inner circumferential surface of the upper through-hole 2H1U, which is substantially rectangular in a plan view, at two contact portions (upper contact portions CT1U and CT2U). Similarly, as illustrated in FIG. 7, the first rod-like member 7A is disposed to contact the inner circumferential surface of the lower through-hole 2H1D, which is substantially rectangular in a plan view, at two contact portions (lower contact portions CT1D and CT2D). That is, the first rod-like member 7A is inserted into each of the upper through-hole 2H1Uand the lower through-hole 2H1Dsuch that the position of the upper contact portion CT1U coincides with the position of the lower contact portion CT1D, and the position of the upper contact portion CT2U coincides with the position of the lower contact portion CT2D in a plan view.

As illustrated in FIG. 7, a height H1 of each of the upper contact portions CT1U and CT2U is greater than a height H2 of the contact portion CT3, and a height H3 of each of the lower contact portions CT1D and CT2D is smaller than the height H2 of the contact portion CT3. The heights H1, H2, and H3 are heights from the bottom surface of the base member 3. That is, the holding member 2 is configured to be supported at three points (contact portions CT1, CT2, and CT3) by the guiding portion GD (first rod-like member 7A and second rod-like member 7B) in a side view. This configuration has the effect of stably supporting the holding member 2 using the guiding portion GD (first rod-like member 7A and second rod-like member 7B).

Also, the first rod-like member 7A is fitted into the through-hole 3H1 such that the entire circumference of the cylindrical surface contacts the inner circumferential surface of the through-hole 3H1, as illustrated in the lower-right diagram of FIG. 9. The through-hole 3H1 is formed in the bottom surface of a recess 3Q (recess 3Q1) that is recessed downward and substantially rectangular in a plan view. The first rod-like member 7A is disposed to contact the inner wall surface of the recess 3Q1 at four contact portions (contact portions CT11 to CT14) on the cylindrical surface. Similarly, the second rod-like member 7B is fitted into the through-hole 3H2 such that the entire circumference of the cylindrical surface contacts the inner circumferential surface of the through-hole 3H2, as illustrated in the lower-left diagram of FIG. 9. The through-hole 3H2 is formed in the bottom surface of the recess 3Q (recess 3Q2) that is recessed downward and substantially rectangular in a plan view. The second rod-like member 7B is disposed to contact the inner wall surface of the recess 3Q2 (see FIG. 2) at four contact portions (contact portions CT21 to CT24) on the cylindrical surface.

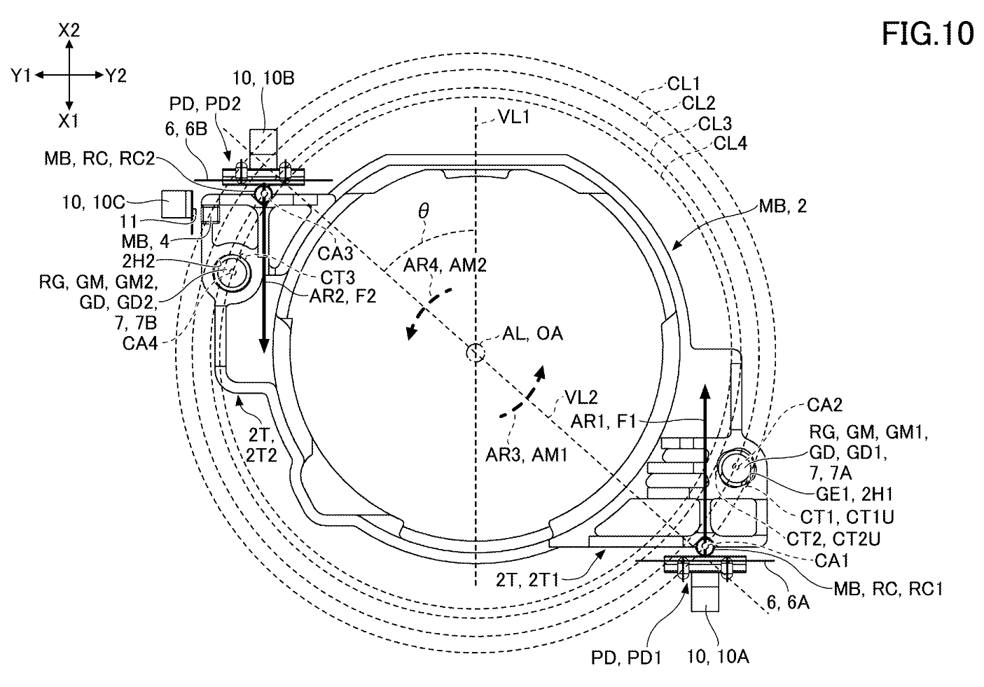

Next, the positional relationship between the piezoelectric driver PD and the movable member MB will be described with reference to FIG. 10. FIG. 10 is a top plan diagram of the biasing member 6, the movable member MB, and the piezoelectric driver PD. Imaginary circles CL1 to CL4 indicated by broken lines in FIG. 10 are circles centered on the optical axis OA serving as the center axis AL. Specifically, the imaginary circle CL1 is a circle passing through a center axis CA1 of the first receiving member RC1 (a circle having a radius that is a distance between the optical axis OA and the center axis CA1). The imaginary circle CL2 is a circle passing through a center axis CA2 of the first rod-like member 7A (a circle having a radius that is a distance between the optical axis OA and the center axis CA2). The imaginary circle CL3 is a circle passing through a center axis CA3 of the second receiving member RC2 (a circle having a radius that is a distance between the optical axis OA and the center axis CA3). The imaginary circle CL4 is a circle passing through a center axis CA4 of the second rod-like member 7B (a circle having a radius that is a distance between the optical axis OA and the center axis CA4). The radius of the imaginary circle CL1 is larger than the radius of the imaginary circle CL2, the radius of the imaginary circle CL2 is larger than the radius of the imaginary circle CL3, and the radius of the imaginary circle CL3 is larger than the radius of the imaginary circle CL4.

A bold solid-line arrow AR1 indicates the direction and magnitude of a biasing force F1 of the first biasing member 6A, and a bold solid-line arrow AR2 indicates the direction and magnitude of a biasing force F2 of the second biasing member 6B. Specifically, the biasing force F1 of the first biasing member 6A is a force applied by the first biasing member 6A to press the first piezoelectric driver PD1 against the first receiving member RC1, and the biasing force F2 of the second biasing member 6B is a force applied by the second biasing member 6B to press the second piezoelectric driver PD2 against the second receiving member RC2. When the first piezoelectric driver PD1 in contact with the first receiving member RC1 is biased by the first biasing member 6A, the holding member 2 presses the inner circumferential surface of the through-hole 2H1 against the first rod-like member 7A. As a result, the first rod-like member 7A and the inner circumferential surface of the through-hole 2H1 contact each other at two contact portions (contact portions CT1 and CT2). When the second piezoelectric driver PD2 in contact with the second receiving member RC2 is biased by the second biasing member 6B, the holding member 2 presses the inner circumferential surface of the through-hole 2H2 against the second rod-like member 7B. As a result, the second rod-like member 7B and the inner circumferential surface of the through-hole 2H2 contact each other at one contact portion (contact portion CT3).

In the illustrated example, the direction (X2 direction) of the biasing force F1 of the first biasing member 6A and the direction (X1 direction) of the biasing force F2 of the second biasing member 6B are opposite to each other. Also, the magnitude of the biasing force F1 of the first biasing member 6A and the magnitude of the biasing force F2 of the second biasing member 6B are substantially the same as each other. That is, the biasing force F1 and the biasing force F2 can be regarded as forming a force couple. However, the magnitude of the biasing force F1 and the magnitude of the biasing force F2 may be different from each other, and the direction of the biasing force F1 and the direction of the biasing force F2 may be non-parallel to each other.

A bold dot-line arrow AR3 indicates the direction and magnitude of a first rotational force (first rotational moment AM1 with respect to the center axis AL (optical axis OA)) applied to the movable member MB by the biasing force F1 of the first biasing member 6A. A bold dot-line arrow AR4 indicates the direction and magnitude of a second rotational force (second rotational moment AM2 with respect to the center axis AL (optical axis OA)) applied to the movable member MB by the biasing force F2 of the second biasing member 6B.

A first imaginary straight line VL1 is a straight line passing through the optical axis OA and extending in a direction (X-axis direction) parallel to the direction of the biasing force F1 of the first biasing member 6A. A second imaginary straight line VL2 is a straight line passing through the optical axis OA and extending in a direction crossing the direction of the biasing force of the first biasing member 6A. In the illustrated example, the second imaginary straight line VL2 is disposed such that an angle θ between the first imaginary straight line VL1 and the second imaginary straight line VL2 is a predetermined angle (45 degrees).

As illustrated in FIG. 10, the first biasing member 6A is disposed on the front side (X1 side) of the first receiving member RC1 attached to the front surface of the first projection 2T1 of the holding member 2, and the second biasing member 6B is disposed on the rear side (X2 side) of the second receiving member RC2 attached to the rear surface of the second projection 2T2 of the holding member 2. That is, the first biasing member 6A is disposed on the front side of the optical axis OA, and the second biasing member 6B is disposed on the rear side of the optical axis OA. The first biasing member 6A is disposed on the right side (Y2 side) of the first imaginary straight line VL1, and the second biasing member 6B is disposed on the left side (Y1 side) of the first imaginary straight line VL1. The first biasing member 6A and the second biasing member 6B are disposed to face each other across the optical axis OA in the extending direction of the second imaginary straight line VL2.

With this disposition, the first biasing member 6A can press the first piezoelectric driver PD1 against the first receiving member RC1 to contact the first guided portion GE1 (inner circumferential surface of the through-hole 2H1) with the front side (X1 side) of the first guiding portion GD1 (cylindrical surface of the first rod-like member 7A). Also, the second biasing member 6B can press the second piezoelectric driver PD2 against the second receiving member RC2 to contact the second guided portion GE2 (inner circumferential surface of the through-hole 2H2) with the rear side (X2 side) of the second guiding portion GD2 (cylindrical surface of the second rod-like member 7B). That is, even if no power is supplied to the piezoelectric driver PD, the holding member 2 is sandwiched between the biasing member 6 and the rod-like member 7, and movement of the holding member 2 along the first direction (Z-axis direction) is suppressed.

As described above, the piezoelectric driving device 101 according to the embodiment of the present disclosure includes the supporting member FB, the movable member MB having the center axis AL extending in the first direction (Z-axis direction), and the piezoelectric driver PD configured to move the movable member MB along the first direction (Z-axis direction) relative to the supporting member FB, as illustrated in FIG. 2. The piezoelectric driver PD includes the first piezoelectric driver PD1 and the second piezoelectric driver PD2. The movable member MB includes the first receiving member RC1 configured to contact the first piezoelectric driver PD1 and receive the movement of the first piezoelectric driver PD1, and the second receiving member RC2 configured to contact the second piezoelectric driver PD2 and receive the movement of the second piezoelectric driver PD2. In the illustrated example, the piezoelectric driving device 101 includes the two piezoelectric drivers PD (first piezoelectric driver PD1 and second piezoelectric driver PD2). However, the piezoelectric driving device 101 may include three or more piezoelectric drivers PD.

This configuration, including a plurality of piezoelectric drivers PD, has the effect of providing a driving force (thrust) larger than that provided in a configuration including only one piezoelectric driver PD. Therefore, this configuration can appropriately move the movable member MB even if the relatively heavy driven body DB is attached to the movable member MB. Also, compared to use of a single large piezoelectric driver configured to generate a driving force equivalent to the driving force of the plurality of piezoelectric drivers PD, this configuration has the effect of increasing efficiency in usage of the space in the housing HS, and hence, downsizing the piezoelectric driving device 101.

Also, the first piezoelectric driver PD1 may be biased toward the first receiving member RC1 (movable member MB side, X2 side) by the first biasing member 6A supported by the supporting member FB, and the second piezoelectric driver PD2 may be biased toward the second receiving member RC2 (movable member MB side, X1 side) by the second biasing member 6B supported by the supporting member FB. Further, as illustrated in FIG. 10, the first piezoelectric driver PD1 and the first biasing member 6A may be disposed such that the first rotational moment AM1 with respect to the center axis AL is applied to the movable member MB by the biasing force F1 of the first biasing member 6A. The second piezoelectric driver PD2 and the second biasing member 6B may be disposed such that the second rotational moment AM2 with respect to the center axis AL is applied to the movable member MB by the biasing force F2 of the second biasing member 6B. The direction of the first rotational moment AM1 and the direction of the second rotational moment AM2 are the same as each other. In the example illustrated in FIG. 10, both the direction of the first rotational moment AM1 and the direction of the second rotational moment AM2 are counterclockwise in a plan view. Also, a restricting portion RG (rod-like member 7) configured to restrict the rotation of the movable member MB about the center axis AL due to the first rotational moment AM1 and the second rotational moment AM2 may be provided to be immovable relative to the supporting member FB. In the illustrated example, the piezoelectric driving device 101 includes two separate biasing members 6 (first biasing member 6A and second biasing member 6B). However, the piezoelectric driving device 101 may be configured to include a single biasing member 6. That is, the single biasing member 6 may be used in common as both the first biasing member 6A and the second biasing member 6B. In other words, the first biasing member 6A and the second biasing member 6B may be integrated together.

Since this configuration does not need the direction of the biasing force F1 of the first biasing member 6A and the direction of the biasing force F2 of the second biasing member 6B to coincide with each other, it is possible to increase the degree of freedom in the disposition of the first piezoelectric driver PD1 and the second piezoelectric driver PD2. Therefore, for example, this configuration can increase efficiency in usage of the space in the housing HS, and hence, suppress an increase in size of the piezoelectric driving device 101.

Also, when viewed along the first direction (Z-axis direction), the first piezoelectric driver PD1 and the second piezoelectric driver PD2 included in the piezoelectric driving device 101 may be respectively disposed on one side (Y2 side, right side) and on the other side (Y1 side, left side) across the first imaginary straight line VL1 that passes through the center axis AL and is parallel to the direction (X-axis direction) of the biasing force F1 of the first biasing member 6A, as illustrated in FIG. 10.

This configuration has the effect of increasing efficiency in usage of the space in the housing HS, and hence, downsizing the piezoelectric driving device 101.

Also, when viewed along the first direction (Z-axis direction), the first piezoelectric driver PD1 and the second piezoelectric driver PD2 included in the piezoelectric driving device 101 may be disposed to face each other in a direction of the second imaginary straight line VL2 that passes through the center axis AL and crosses the direction (X-axis direction) of the biasing force F1 of the first biasing member 6A, as illustrated in FIG. 10. In the example illustrated in FIG. 10, the direction of the biasing force F1 of the first biasing member 6A (X2 direction) and the direction of the biasing force F2 of the second biasing member 6B (X1 direction) are opposite to each other. Further, the first piezoelectric driver PD1 and the second piezoelectric driver PD2 are disposed to be substantially point-symmetric (two-fold rotationally symmetric) with respect to the center axis AL in a plan view.

This configuration has the effect of stabilizing the movement of the movable member MB in the first direction (Z-axis direction) compared to a configuration in which the first piezoelectric driver PD1 and the second piezoelectric driver PD2 are disposed not to face each other across the center axis AL. This is because the driving force can be applied to the movable member MB from both sides in a balanced manner. When the piezoelectric driving device 101 includes three piezoelectric drivers PD, the three piezoelectric drivers PD may be disposed to be three-fold rotationally symmetric with respect to the center axis AL in a plan view. When the piezoelectric driving device 101 includes four piezoelectric drivers PD, the four piezoelectric drivers PD may be disposed to be four-fold rotationally symmetric with respect to the center axis AL in a plan view.

Also, as illustrated in FIG. 2, the restricting portion RG (rod-like member 7) may form the guiding portion GD when the movable member MB moves along the first direction (Z-axis direction). Further, the movable member MB may include the guided portion GE (through-hole 2H) configured to be guided by the guiding portion GD.

This configuration has the effect of stably guiding the movable member MB along the first direction (Z-axis direction) since the movable member MB can be pressed against the restricting portion RG (rod-like member 7) due to the rotational moment applied by the biasing member 6.

Also, as illustrated in FIG. 2, the guiding portion GD may include the first guiding portion GD1 (first rod-like member 7A) and the second guiding portion GD2 (second rod-like member 7B). In this case, each of the first guiding portion GD1 (first rod-like member 7A) and the second guiding portion GD2 (second rod-like member 7B) may be formed of a metal or ceramic material extending in the first direction (Z-axis direction). Further, the guided portion GE may include the first guided portion GE1 (through-hole 2H1) slidable relative to the first guiding portion GD1 (first rod-like member 7A), and the second guided portion GE2 (through-hole 2H2) slidable relative to the second guiding portion GD2 (second rod-like member 7B).

This configuration has the effect of more smoothly guiding the movement of the movable member MB in the first direction (Z-axis direction) compared to when only one guiding portion GD is used.

Also, in the piezoelectric driving device 101, when viewed along the first direction (Z-axis direction), one (through-hole 2H1) of the first guided portion GE1 (through-hole 2H1) or the second guided portion GE2 (through-hole 2H2) may be disposed to contact one (first rod-like member 7A) of the first guiding portion GD1 (first rod-like member 7A) or the second guiding portion GD2 (second rod-like member 7B) at two points (contact portions CT1 and CT2). Further, the other (through-hole 2H2) of the first guided portion GE1 (through-hole 2H1) or the second guided portion GE2 (through-hole 2H2) may be disposed to contact the other (second rod-like member 7B) of the first guiding portion GD1 (first rod-like member 7A) or the second guiding portion GD2 (second rod-like member 7B) at one point (contact portion CT3), as illustrated in FIG. 9.

In this configuration, the movable member MB is supported at three points by the guiding portion GD (rod-like member 7) in a plan view. Therefore, this configuration has the effect of stabilizing the posture of the movable member MB compared to the case in which the movable member MB is supported at one point or two points by the guiding portion GD (rod-like member 7) in a plan view.

Also, in the piezoelectric driving device 101, when viewed along the direction perpendicular to the first direction (Z-axis direction), one (through-hole 2H1) of the first guided portion GE1 (through-hole 2H1) or the second guided portion GE2 (through-hole 2H2) may be disposed to contact one (first rod-like member 7A) of the first guiding portion GD1 (first rod-like member 7A) or the second guiding portion GD2 (second rod-like member 7B) at two positions (first position PS1 and second position PS2), as illustrated in FIG. 7. Further, the other (through-hole 2H2) of the first guided portion GE1 (through-hole 2H1) or the second guided portion GE2 (through-hole 2H2) may be disposed to contact the other (second rod-like member 7B) of the first guiding portion GD1 (first rod-like member 7A) or the second guiding portion GD2 (second rod-like member 7B) at one position (third position PS3).

In this configuration, the movable member MB is supported at three points by the guiding portion GD (rod-like member 7) in a side view. Therefore, this configuration has the effect of stabilizing the posture of the movable member MB compared to the case in which the movable member MB is supported at one point or two points by the guiding portion GD (rod-like member 7) in a side view.

Also, as illustrated in FIG. 10, the first guiding portion GD1 (first rod-like member 7A) may be disposed to substantially face the first piezoelectric driver PD1 in the biasing direction of the first biasing member 6A to correspond to the first piezoelectric driver PD1. Similarly, the second guiding portion GD2 (second rod-like member 7B) may be disposed to substantially face the second piezoelectric driver PD2 in the biasing direction of the second biasing member 6B to correspond to the second piezoelectric driver PD2.

This configuration has the effect that the first guiding portion GD1 (first rod-like member 7A) can receive the first rotational moment AM1 (or the biasing force F1) due to the first biasing member 6A, and the second guiding portion GD2 (second rod-like member 7B) can receive the second rotational moment AM2 (or the biasing force F2) due to the second biasing member 6B. Therefore, this configuration has the effect of continuously contacting the movable member MB with the guiding portion GD even if no power is supplied to the piezoelectric driver PD. That is, this configuration has the effect of suppressing an unintentional movement of the movable member MB along the first direction (Z-axis direction) when no power is supplied to the piezoelectric driver PD.

Also, as illustrated in FIG. 3, the first piezoelectric driver PD1 may include the first piezoelectric element 8A extending in a direction (Y-axis direction) crossing the first direction (Z-axis direction), and the first contact member 9A configured to be fixed to one surface (rear surface) of the first piezoelectric element 8A on the first receiving member RC1 side (X2 side) and configured to contact the first receiving member RC1. Similarly, the second piezoelectric driver PD2 may include the second piezoelectric element 8B extending in a direction (Y-axis direction) crossing the first direction (Z-axis direction), and the second contact member 9B configured to be fixed to one surface (front surface) of the second piezoelectric element 8B on the second receiving member RC2 side (X1 side) and configured to contact the second receiving member RC2. Each of the first receiving member RC1, the first contact member 9A, the second receiving member RC2, and the second contact member 9B may be formed of a metal or ceramic.

For example, this configuration has the effect of enhancing durability of the piezoelectric driving device 101 compared to the case in which at least one of the first receiving member RC1, the first contact member 9A, the second receiving member RC2, or the second contact member 9B is formed of a synthetic resin. Further, this configuration has the effect of suppressing formation of wear powder or the like due to contact between two of the first receiving member RC1, the first contact member 9A, the second receiving member RC2, and the second contact member 9B compared to the case in which at least one of the first receiving member RC1, the first contact member 9A, the second receiving member RC2, or the second contact member 9B is formed of a synthetic resin.

Also, as illustrated in FIG. 3, the first biasing member 6A may be formed by the first leaf spring, and the first flexible wiring board 10A configured to apply a voltage to the first piezoelectric element 8A may be fixed to the other surface (X1-side surface, front surface) of the first piezoelectric element 8A. Similarly, the second biasing member 6B may be formed by the second leaf spring, and the second flexible wiring board 10B configured to apply a voltage to the second piezoelectric element 8B may be fixed to the other surface (X2-side surface, rear surface) of the second piezoelectric element 8B.

This configuration has the effect of simplifying the structure of the piezoelectric driving device 101 compared to the case in which the biasing member 6 is formed by a member other than the leaf spring. Further, this configuration has the effect of simplifying the structure of the piezoelectric driving device 101 compared to the case in which a conductive path for application of a voltage to the piezoelectric element 8 is formed of a member other than the flexible wiring board.

Also, as illustrated in FIG. 1, the camera module CM according to the embodiment of the present disclosure includes the piezoelectric driving device 101, the lens body LS held by the movable member MB, and the imaging element IS disposed to face the lens body LS.

This configuration has the effect of appropriately moving the movable member MB even if the lens body LS is relatively heavy.

The embodiments of the present disclosure have been described in detail. However, the present disclosure is not limited to the above-described embodiments. Various modifications, substitutions, or the like may be applied to the above-described embodiments without departing from the scope of the present disclosure. Also, the features described with reference to the above-described embodiments are suitably combined, as long as there is no technical contradiction.

The above configurations can achieve a larger driving force (thrust).

What is claimed is:

1. A piezoelectric driving device, comprising:
a supporting member;
a movable member having a center axis extending in a first direction; and
a piezoelectric driver configured to move the movable member along the first direction relative to the supporting member, wherein
the piezoelectric driver includes a first piezoelectric driver and a second piezoelectric driver,
the movable member includes a first receiving portion and a second receiving portion, and
the first receiving portion is configured to contact the first piezoelectric driver and receive movement of the first piezoelectric driver, and the second receiving portion is configured to contact the second piezoelectric driver and receive movement of the second piezoelectric driver.

2. The piezoelectric driving device according to claim 1, wherein
the first piezoelectric driver is configured to be biased toward the first receiving portion by a first biasing member supported by the supporting member,
the second piezoelectric driver is configured to be biased toward the second receiving portion by a second biasing member supported by the supporting member,
the first piezoelectric driver and the first biasing member are disposed such that a first rotational moment with respect to the center axis is applied to the movable member by a biasing force of the first biasing member,
the second piezoelectric driver and the second biasing member are disposed such that a second rotational moment with respect to the center axis is applied to the movable member by a biasing force of the second biasing member,
a direction of the first rotational moment is the same as a direction of the second rotational moment, and
a restricting portion is disposed to be immovable relative to the supporting member, and is configured to restrict rotation of the movable member about the center axis due to the first rotational moment and the second rotational moment.

3. The piezoelectric driving device according to claim 2, wherein
as viewed along the first direction, the first piezoelectric driver and the second piezoelectric driver are disposed on opposite sides of a first imaginary straight line that passes through the center axis and is parallel to a direction of the biasing force applied by the first biasing member.

4. The piezoelectric driving device according to claim 2, wherein
as viewed along the first direction, the first piezoelectric driver and the second piezoelectric driver are disposed to face each other in a direction of a second imaginary straight line that passes through the center axis and crosses a direction of the biasing force applied by the first biasing member.

5. The piezoelectric driving device according to claim 2, wherein
the restricting portion forms a guiding portion during movement of the movable member along the first direction, and
the movable member includes a guided portion configured to be guided by the guiding portion.

6. The piezoelectric driving device according to claim 5, wherein
the guiding portion includes a first guiding portion and a second guiding portion,
each of the first guiding portion and the second guiding portion is formed of a metal or ceramic material extending in the first direction, and
the guided portion includes a first guided portion that is slidable relative to the first guiding portion, and a second guided portion that is slidable relative to the second guiding portion.

7. The piezoelectric driving device according to claim 6, wherein
as viewed along the first direction,
one of the first guided portion or the second guided portion is disposed to contact one of the first guiding portion or the second guiding portion at two points, and
another of the first guided portion or the second guided portion is disposed to contact another of the first guiding portion or the second guiding portion at one point.

8. The piezoelectric driving device according to claim 6, wherein
as viewed along a direction perpendicular to the first direction,
one of the first guided portion or the second guided portion is disposed to contact one of the first guiding portion or the second guiding portion at two positions, and
another of the first guided portion or the second guided portion is disposed to contact another of the first guiding portion or the second guiding portion at one position.

9. The piezoelectric driving device according to claim 6, wherein
the first guiding portion is disposed to substantially face the first piezoelectric driver in a biasing direction of the first biasing member to correspond to the first piezoelectric driver, and
the second guiding portion is disposed to substantially face the second piezoelectric driver in a biasing direction of the second biasing member to correspond to the second piezoelectric driver.

10. The piezoelectric driving device according to claim 1, wherein
the first piezoelectric driver includes a first piezoelectric element extending in a direction crossing the first direction, and a first contact member configured to be fixed to one surface of the first piezoelectric element facing the first receiving portion and configured to contact the first receiving portion,
the second piezoelectric driver includes a second piezoelectric element extending in the direction crossing the first direction, and a second contact member configured to be fixed to one surface of the second piezoelectric element facing the second receiving portion and configured to contact the second receiving portion, and
each of the first receiving portion, the first contact member, the second receiving portion, and the second contact member is formed of a metal or ceramic.

11. The piezoelectric driving device according to claim 2, wherein
the first piezoelectric driver includes a first piezoelectric element extending in a direction crossing the first direction, and a first contact member configured to be fixed to one surface of the first piezoelectric element facing the first receiving portion and to contact the first receiving portion,
the second piezoelectric driver includes a second piezoelectric element extending in the direction crossing the first direction, and a second contact member configured to be fixed to one surface of the second piezoelectric element facing the second receiving portion and to contact the second receiving portion,
each of the first receiving portion, the first contact member, the second receiving portion, and the second contact member is formed of a metal or ceramic,
the first biasing member is formed by a first leaf spring, and a first flexible wiring board configured to apply a voltage to the first piezoelectric element is fixed to another surface of the first piezoelectric element, and
the second biasing member is formed by a second leaf spring, and a second flexible wiring board configured to apply a voltage to the second piezoelectric element is fixed to another surface of the second piezoelectric element.

12. A camera module, comprising:
the piezoelectric driving device of claim 1;
a lens body held by the movable member; and
an imaging element disposed to face the lens body.
